(19) United States
(12) Patent Application Publication
(10) Pub. No.: US 2011/0153583 A1
(43) Pub. Date: Jun. 23, 2011

(54) URL PROXY METHOD AND APPARATUS

(75) Inventor: Adam GOLDBAND, Antioch, CA (US)

(73) Assignee: CBS INTERACTIVE, INC., San Francisco, CA (US)

(21) Appl. No.: 12/645,614

(22) Filed: Dec. 23, 2009

(51) Int. Cl. G06F 15/16; G06F 17/30

(52) U.S. Cl. 707/706; 707/769; 709/248; 709/203; 707/E17.108; 707/723

(57) ABSTRACT

Embodiments of the present invention relate to a method for mapping complex and simple URLs, including navigating a database storing an electronic catalog of product records, wherein the catalog comprises a taxonomy of product categories and products within the categories, receiving a webpage request corresponding to a product record in the catalog, the webpage request having a first URL address associated with it upon a user selecting the webpage to view, wherein the first URL is determined based on location of the product record in the taxonomy, accessing a mapping rule which matches the first URL address to a stored second URL address, and redirecting the first URL address to the second URL address by processing the mapping rule, wherein the first URL address is no longer displayed as a website address and the second URL address is displayed on a screen as the website address from the webpage.

### TECHNICAL FIELD

The present disclosure relates to a method, system, and computer-readable medium for masking complex URLs with simple URLs within a taxonomy of content items, such as a product catalog.

### BACKGROUND OF THE INVENTION

While searching on the Internet, as a user moves from page to page on a Website the URL gets longer and more convoluted as more and more information is tracked. The more complex a Website's directory structure, the longer the URL is going to be. As an example, on line catalogs include product records arranged in a taxonomy of product categories and products within the categories. The records include attributes which describe products in a category. URLs for the product records are determined based on location of the product record in the taxonomy. Also, the catalogs are often searched by specifying filters. The resulting URL of a product record can reflect the filter selection resulting in the product. As an example, a URL for a specific laptop computer could be http://reviews.cnet.com/laptops/sony-vaio-fw560f-t/4505-3121_{—}7-3776105.html?tag=mncol;lst. Of course, this complex URL does not have clear meaning to a human user. Also, it is not descriptive enough to fully take advantage Search Engine Optimization (SEO) techniques. In view of the vast number of Websites on the World Wide Web, and the considerable amount of content contained in each site, the complexity of organization of this information will also continue to increase in complexity. This complexity in organization leads to long and non descriptive (“ugly”) URLs located in the address bar of the browser and associated with web page. It is well known to map long URLs to shorter URLs, such as by using the TinyURL or Bitly services. More recently, rewrite rules and proxying techniques have been used in an attempt to simplify “ugly” URLs into a more readable form, however these conventional techniques are prone to circular redirection errors, and thus often ineffective.

### SUMMARY OF THE INVENTION

Embodiments disclosed herein relate to a method involving steps to be performed on a computing system for masking a complex URL with a simple URL, including navigating a database storing an electronic catalog of product records, wherein the catalog comprises a taxonomy of product categories and products within the categories, the catalog further comprising attributes which describe products in a category and at least one value for said attributes, receiving a webpage request corresponding to a product record in the catalog, the webpage request having a first URL address associated with it upon a user selecting the webpage to view, wherein the first URL is determined based on location of the product record in the taxonomy, accessing a mapping rule which matches the first URL address to a stored second URL address, and redirecting the first URL address to the second URL address by processing the mapping rule, wherein the first URL address is no longer displayed as a website address and the second URL address is displayed on the screen as the website address from the webpage.

The embodiments of the present invention also relate to a system for masking a complex URL with a simple URL, including means for navigating a database storing an electronic catalog of product records, wherein the catalog comprises a taxonomy of product categories and products within the categories, the catalog further comprising attributes which describe products in a category and at least one value for said attributes, means for receiving a webpage request corresponding to a product record in the catalog, the webpage request having a first URL address associated with it upon a user selecting the webpage to view, wherein the first URL is determined based on location of the product record in the taxonomy, means for accessing a mapping rule which matches the first URL address to a stored second URL address, and means for redirecting the first URL address to the second URL address by processing the mapping rule, wherein the first URL address is no longer displayed as a website address and the second URL address is displayed on the screen as the website address from the webpage.

Furthermore, the embodiments of the present invention relate to a computer-readable medium for masking a complex URL with a simple URL, including means for navigating a database storing an electronic catalog of product records, wherein the catalog comprises a taxonomy of product categories and products within the categories, the catalog further comprising attributes which describe products in a category and at least one value for said attributes, means for receiving a webpage request corresponding to a product record in the catalog, the webpage request having a first URL address associated with it upon a user selecting the webpage to view, wherein the first URL is determined based on location of the product record in the taxonomy, means for accessing a mapping rule which matches the first URL address to a stored second URL address, and means for redirecting the first URL address to the second URL address by processing the mapping rule, wherein the first URL address is no longer displayed as a website address and the second URL address is displayed on the screen as the website address from the webpage.

Additionally, the embodiments of the present invention relate to a method for mapping a complex URL to a simple URL including synching a plurality of servers such that when the mapping rule is changed, or a new mapping rule is created, the plurality of servers receive this information simultaneously, thereby avoiding redirect loops, substituting a HTML tag of the ugly URL with an HTML tag of the simple URL, thereby avoiding redirect loops, and customizing the second URL to include keywords so that the second URL receives a high ranking by search engines.

The embodiments of the present invention further relate to a system for mapping a complex URL to a simple URL including means for synching a plurality of servers such that when the mapping rule is changed, or a new mapping rule is created, the plurality of servers receive this information simultaneously, thereby avoiding redirect loops, means for substituting a HTML tag of the ugly URL with an HTML tag of the simple URL, thereby avoiding redirect loops, and means for customizing the second URL to include keywords so that the second URL receives a high ranking by search engines.

In addition, the embodiments of the present invention relate to a computer-readable medium for mapping a complex URL to a simple URL including means for synching a plurality of servers such that when the mapping rule is changed, or a new mapping rule is created, the plurality of servers receive this information simultaneously, thereby avoiding redirect loops, means for substituting a HTML tag of the ugly URL with an HTML tag of the simple URL, thereby avoiding redirect loops, and means for customizing the second URL to include keywords so that the second URL receives a high ranking by search engines.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a functional block diagram of a computer architecture in accordance with an embodiment;

FIG. 2 is a structural block diagram of a computer architecture in accordance with an embodiment including a URL mapping database;

FIG. 3 is a schematic representation of the URL mapping database; and

FIG. 4 is a flowchart for masking a complex URL with a simple URL.

### DETAILED DESCRIPTION OF THE PREFERRED EMBODIMENT

The embodiments create simple/readable URLs that are used in place of machine made and/or complex URLs that are commonly used as website addresses or links thereto, without the normal redirection loop that other previous technologies are unable to avoid, thereby eliminating circular redirect issues. The present invention can be used on any Website, and the new simple URLs described herein are extremely valuable from a search engine optimization (SEO) standpoint, in that the simple URLs can be customized to include keywords that are desirable by search engines.

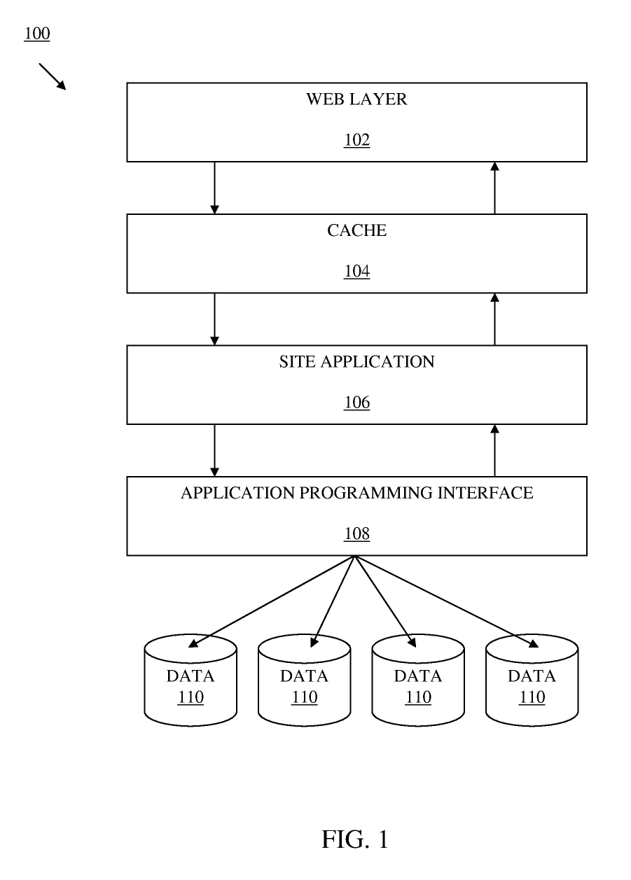

A functional illustration of the computer architecture of a preferred embodiment of the present invention is depicted by FIG. 1. System architecture 100 includes a web layer 102, a cache 104, a site application 106, an application programming interface 108, and a plurality of data stores 110. However, as is understood, the system architecture may vary from the illustrated architecture. For example, web layer 102 may directly access data stores 110, the site application 106 may directly access data stores 110, system architecture 100 may not include cache 104, etc., as will be appreciated by those skilled in the art. Web layer 102 is configured to receive user requests to access content through a web browser and return content that is responsive to the user request. Web layer 102 communicates the user requests to cache 104. Cache 104 is configured to temporarily store content that is accessed frequently by web layer 102 and can be rapidly accessed by web layer 102. In one embodiment, cache 104 may be a caching proxy server. Cache 104 communicates the user requests to site application 106.

Site application 106 is configured to update cache 104 and to process user requests received from web layer 102. Site application 106 may identify that the user request is for a page that includes data from multiple sources. Site application 106 can then convert the page request into a request for content from multiple sources and transmits these requests to application programming interface 108. Application programming interface 108 is configured to simultaneously access data from the plurality of data stores 110 to collect the data responsive to the plurality of requests from site application 106. The plurality of data stores 110 may include, for example, catalogue data about different product types (e.g., product specifications, pricing, images, etc.), content components, and the like. It will be appreciated that in alternative embodiments only one data store 110 may be provided to store the data.

The data in data stores 110 is provided to application programming interface 108, which provides the content to site application 106. Site application 106 updates cache 104 and delivers the cached content in combination with the accessed content to web layer 110, which delivers browsable content to the user, such as through a product landing page.

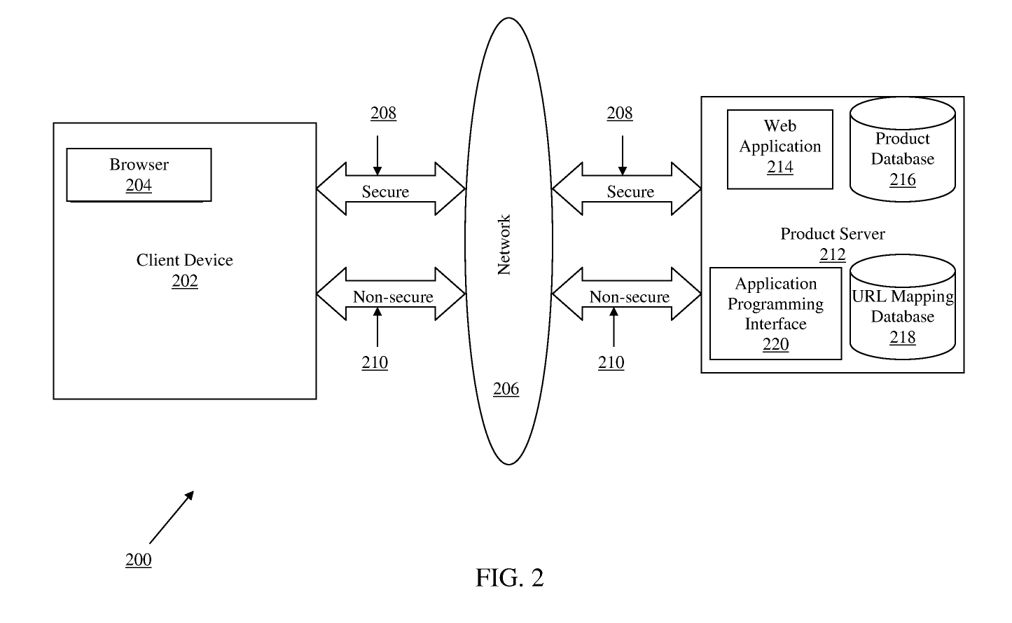

A structural illustration of a preferred embodiment of a computer architecture of the present invention can be seen in FIG. 2. Customizable uniform resource locator (URL) system 200 includes client computer 202, which executes browser application 204 that supports the HTTP protocol, or other appropriate protocols. Client computer 202 is connected, typically through an ISP (Internet Service Provider), to Network 206 serving as a communication channel. For example, client computer 202 can be coupled to the ISP through a broadband connection such as ISDN (Integrated Services Digital Network), a cable modem, or a DSL (Digital Subscriber Line) connection. Product server 212 is also coupled to the Internet 206 in a known manner. Product server 212 executes, for example, a web application 214, known as an HTTP server application, stored in a memory device. For example, public domain web server software applications from NCSA or APACHE can be used.

In the preferred embodiment, both of the client computer 202 and the product server 212 can be capable of communicating using a secure connection protocol, such as SSL or S-HTTP. For clarity, non-secure connections 210 and secure connections 208 are illustrated separately. However, typically, these connections will be effected over the same physical connection or communication channel, such as Internet. Further, product server 212 can have many product landing pages stored in memory devices thereof, such as HTML format and/or other formats. Product server 212 also includes product database 216 stored in the memory device thereof as described in detail below. Product database 216 stores product record data for at least one product. Product record data may include a product's price, type, dimensions, weight, material, color, display type, sound output, accessories, operating system, and manufacturer, among other things. Client computer 202 can request a display of a product page from product server 212 by issuing a URL request through the Internet to product server 212. For example, a user of client computer 202, i.e., a searcher, can enter a product query, including at least one product term(s) and/or attribute, into a form page displayed by browser 204, or merely clicking a link for an item and/or product. The browser interface can be populated with suggested product landing pages that are based on the product search criteria from product database 216. The user can select a product landing page to be viewed.

Product server 212 executes, for example, an application programming interface (API) 120 that requests product landing pages, once the web application 214 has received a request for a product landing page. Product server 212 also includes a URL mapping database 218 that stores easily readable URLs which are mapped to complex or “ugly” URLs. An ugly URL can be, for instance, the URL that is automatically assigned when a URL is created. For example, when navigating an electronic catalog of products organized in a taxonomy, the products are often assigned a complex URL based on the product's position within the taxonomy. If a simple URL exists for the requested page, then the system masks the “ugly” URL for the requested page such that the simple URL automatically appears in the URL address line.

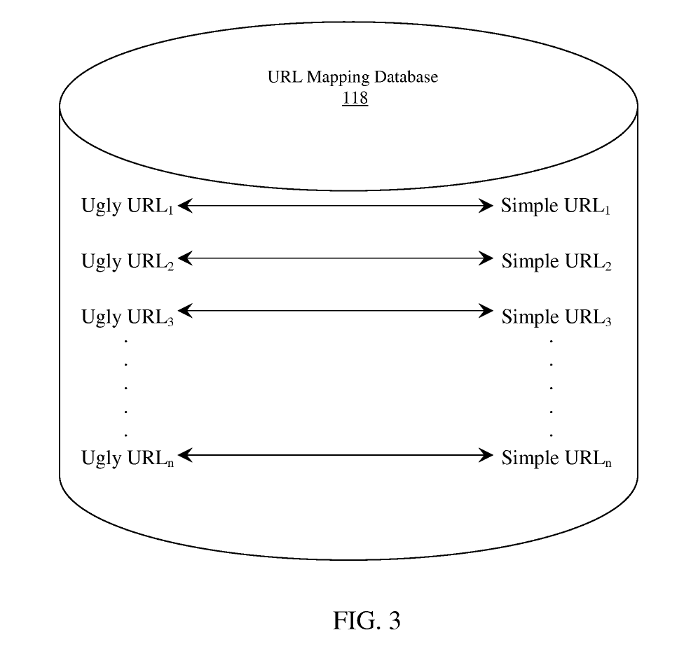

A more detailed illustration of the URL mapping database 118 can be seen in FIG. 3. Specifically, a plurality of “ugly” URLs (i.e., Ugly URL1, Ugly URL2, Ugly URL3 through Ugly URLn) are each respectively mapped to a simple URL (e.g., Simple URL1, Simple URL2, Simple URL3 through Simple URLn) and stored in the URL mapping database 118.

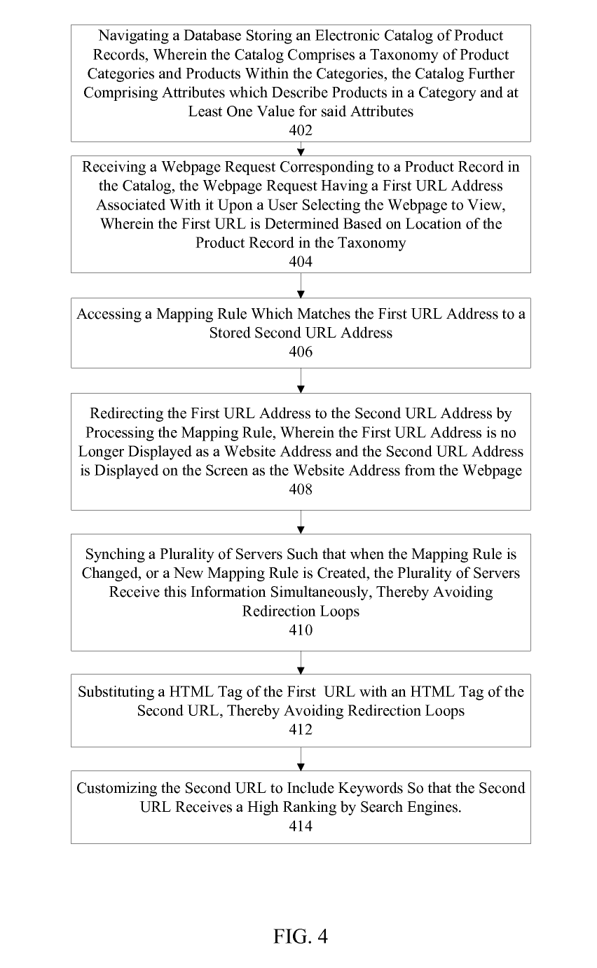

FIG. 4 illustrates a flowchart for masking a complex URL with a simple URL. Each step of FIG. 4 will be described in greater detail below. In step 402 a database storing an electronic catalog of products is navigated, wherein the catalog comprises a taxonomy of product records within the categories, the catalog further comprises attributes which describe products in a category and at least one value for the attributes. Next, in step 404, a webpage request corresponding to a product record in the catalog is received, the webpage request having a first URL address associated with it upon a user selecting the webpage to view, wherein the first URL is determined based on location of the product record in the taxonomy. Step 406 accesses a mapping rule which matches the first URL address to a stored second URL address. The first URL address is redirected to the second URL address by process the mapping rule, wherein the first URL address is no longer displayed as a website address and the second URL address is displayed on the screen as the website address from the webpage in step 408. Next, in step 410, a plurality of servers are synched such that when the mapping rule is changed, or a new mapping rule is created, the plurality of servers receive this information simultaneously, thereby avoiding redirection loops. In step 412, an HTML tag of the first URL is substituted with an HTML tag of the second URL, thereby avoiding redirection loops. Then, the second URL is customized to include keywords such that the second URL receives a high ranking by search engines.

Thus, the above described method and apparatus in accordance with the embodiments of the present invention provides a very effective method for providing reverse dynamic filter-linked pages. As can now be fully appreciated, the present invention facilitates the masking of complex URLs with simple URLs. The invention also facilitates creating a simple URL that will receive a high ranking by search engines.

The invention can be implemented over any type of communications channel, such as the Internet, a local area network (LAN), a wide area network (WAN), direct computer connections, or the like, using any type of communication hardware and protocols. Any type of hardware or combination of hardware can be used for various clients and servers. Accordingly, the term “computer” as used herein, refers to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting products for purchase. The various information can be stored in any format and thus the term “database” as used herein refers to any collection of information such as a database file, a lookup table, or the like. While the content items of the embodiment are catalog items. The invention can be applied to any type of content organized in a hierarchy. For example, the invention can be applied to various content items in a content management system such as audio content, video content, or textual content.

The various functions can be implemented by modules which are computer hardware programmed in a desired manner through instructions stored on tangible computer readable media.

The invention has been described through a preferred embodiment. However, various modifications can be made without departing from the scope of the invention as defined by the appended claims and legal equivalents.

What is claimed is:

1. A method involving steps to be performed on a computing system for masking a complex URL with a simple URL, comprising:
navigating a database storing an electronic catalog of product records, wherein the catalog comprises a taxonomy of product categories and products within the categories, the catalog further comprising attributes which describe products in a category and at least one value for said attributes;
receiving a webpage request corresponding to a product record in the catalog, the webpage request having a first URL address associated with it upon a user selecting the webpage to view, wherein the first URL is determined based on location of the product record in the taxonomy;
accessing a mapping rule which matches the first URL address to a stored second URL address; and
redirecting the first URL address to the second URL address by processing the mapping rule, wherein the first URL address is no longer displayed as a website address and the second URL address is displayed on a screen as the website address from the webpage.

2. A method according to claim 1, further comprising:
synching a plurality of servers such that when the mapping rule is changed, or a new mapping rule is created, the plurality of servers receive this information simultaneously, thereby avoiding redirection loops.

3. A method according to claim 1, further comprising:
substituting a HTML tag of the first URL with an HTML tag of the second URL, thereby avoiding redirection loops.

4. A method according to claim 1, further comprising:
customizing the second URL to include keywords so that the second URL receives a high ranking by search engines.

5. A system for masking a complex URL with a simple URL, comprising:
means for navigating a database storing an electronic catalog of product records, wherein the catalog comprises a taxonomy of product categories and products within the categories, the catalog further comprising attributes which describe products in a category and at least one value for said attributes;
means for receiving a webpage request corresponding to a product record in the catalog, the webpage request having a first URL address associated with it upon a user selecting the webpage to view, wherein the first URL is determined based on location of the product record in the taxonomy;
means for accessing a mapping rule which matches the first URL address to a stored second URL address; and
means for redirecting the first URL address to the second URL address by processing the mapping rule, wherein the first URL address is no longer displayed as a website address and the second URL address is displayed on a screen as the website address from the webpage.

6. A system according to claim 5, further comprising:
means for synching a plurality of servers such that when the mapping rule is changed, or a new mapping rule is created, the plurality of servers receive this information simultaneously, thereby avoiding redirection loops.

7. A system according to claim 5, further comprising:
means for substituting a HTML tag of the first URL with an HTML tag of the second URL, thereby avoiding redirection loops.

8. A system according to claim 5, further comprising:
means for customizing the second URL to include keywords so that the second URL receives a high ranking by search engines.

9. A computer-readable medium having computer executable instructions for causing a computer to mask a complex URL with a simple URL, comprising:
instructions for navigating a database storing an electronic catalog of product records, wherein the catalog comprises a taxonomy of product categories and products within the categories, the catalog further comprising attributes which describe products in a category and at least one value for said attributes;
instructions for receiving a webpage request corresponding to a product record in the catalog, the webpage request having a first URL address associated with it upon a user selecting the webpage to view, wherein the first URL is determined based on location of the product record in the taxonomy;
instructions for accessing a mapping rule which matches the first URL address to a stored second URL address; and
instructions for redirecting the first URL address to the second URL address by processing the mapping rule, wherein the first URL address is no longer displayed as a website address and the second URL address is displayed on a screen as the website address from the webpage.

10. A computer-readable medium according to claim 9, further comprising:
instructions for synching a plurality of servers such that when the mapping rule is changed, or a new mapping rule is created, the plurality of servers receive this information simultaneously, thereby avoiding redirection loops.

11. A computer-readable medium according to claim 9, further comprising:
instructions for substituting a HTML tag of the first URL with an HTML tag of the second URL, thereby avoiding redirection loops.

12. A computer-readable medium according to claim 9, further comprising:
instructions for customizing the second URL to include keywords so that the second URL receives a high ranking by search engines.

13. A system for masking a complex URL with a simple URL, comprising:
A client device coupled to a database storing an electronic catalog of product records, the client device having a user interface operable to navigate the database, wherein the catalog comprises a taxonomy of product categories and products within the categories, the catalog further comprising attributes which describe products in a category and at least one value for said attributes;
a server coupled to the database to receive a webpage request corresponding to a product record in the catalog, the webpage request having a first URL address associated with it upon a user selecting the webpage to view, wherein the first URL is determined based on location of the product record in the taxonomy;
a mapping rule module of the server which matches the first URL address to a stored second URL address; and
a redirector module of the server operative to redirect the first URL address to the second URL address by processing the mapping rule, wherein the first URL address is no longer displayed as a website address and the second URL address is displayed on a screen as the website address from the webpage.

14. A system according to claim 13, further comprising:
a synch module of the server operative to synch a plurality of servers such that when the mapping rule is changed, or a new mapping rule is created, the plurality of servers receive this information simultaneously, thereby avoiding redirection loops.

15. A system according to claim 13, further comprising:
a substitution module of the server operative to substitute a HTML tag of the first URL with an HTML tag of the second URL, thereby avoiding redirection loops.

16. A system according to claim 13, wherein the server customizes the second URL to include keywords so that the second URL receives a high ranking by search engines.

17. A method involving steps to be performed on a computing system for masking a complex URL with a simple URL, comprising:
navigating a database storing content items in an ontology;
receiving a webpage request corresponding to a content item, the webpage request having a first URL address associated with it upon a user selecting the webpage to view, wherein the first URL is determined based on location of the content item in the taxonomy;
accessing a mapping rule which matches the first URL address to a stored second URL address; and
redirecting the first URL address to the second URL address by processing the mapping rule, wherein the first URL address is no longer displayed as a website address and the second URL address is displayed on a screen as the website address from the webpage.
